(19) United States
(12) Patent Application Publication
(10) Pub. No.: US 2015/0047715 A1
(43) Pub. Date: Feb. 19, 2015

(54) VALVE ASSEMBLY FOR USE IN A FUEL DISPENSING SYSTEM

(71) Applicant: James C. Foster, Easley, SC (US)

(72) Inventor: James C. Foster, Easley, SC (US)

(21) Appl. No.: 13/967,777

(22) Filed: Aug. 15, 2013

(51) Int. Cl. B67D 7/32; F16K 17/40

(52) U.S. Cl. CPC B67D 7/3218; F16K 17/40
USPC 137/68.14; 137/559

(57) ABSTRACT

A valve assembly for use in a fuel dispensing system is provided. More particularly, a valve assembly is provided having a body defining a fluid inlet and a fluid outlet, with a channel extending therebetween for a flow of fluid. The valve assembly also includes a test port extending from the valve body and defining a downstream end. The test port is in fluid communication with the channel of the valve body. Additionally, a test port valve is included positioned upstream from the downstream end of the test port.

### FIELD

The present disclosure relates generally to a valve assembly for use in a fuel dispensing system, or more particularly, a valve assembly configured to minimize spillage of fuel during testing.

### BACKGROUND

Fuel dispensing systems, such as those used in commercial fueling establishments (commonly referred to as “gas stations”) contain many safety features and are required to be tested with relative frequency to ensure proper operation. A typical fuel dispensing system may include a fuel source, such as a fuel storage tank, a fuel dispensing station, connection pipes, and a fuel pump to pump the fuel to the fuel dispensing station from the fuel source through the connection pipes. At the base of the fuel dispensing station, a valve assembly is provided that connects the connection pipes to an internal pipe within the fuel dispensing station. The valve assembly is designed to minimize any fuel spillage in instances wherein an outside force causes a failure in the fuel dispensing system. For example, the valve assembly is designed to minimize any fuel spillage when a car runs into or through the fuel dispensing station.

State and/or Federal regulatory agencies require the testing of the fuel dispensing systems to ensure the leaking, if any, of fuel from the fuel source, the connection pipes, or both is below a predetermined amount. Accordingly, certain valve assemblies include a test port that is connected to a main channel in the valve assembly. A plug may be screwed into the end of the test port to block the flow of fuel. In order to test the fuel dispensing system, a worker will turn off the fuel pump for the system, manually close the shutoff valve, and unscrew the plug to relieve the fuel pressure in the fuel dispensing system. However, such a process necessarily allows a certain amount of fuel to spill in the area surrounding the base of the dispensing station. Such spillage may contaminate any soil surrounding the dispensing station (requiring the removal of that soil in some instances), release vapors from the fuel, and increase the time required to test the fuel dispensing systems. Once the pressure in the system has been relieved, the worker may then connect the testing equipment to the test port and conduct the required testing.

Accordingly, a valve assembly for use in a fuel dispensing system that could reduce the spillage of fuel during the testing of the fuel dispensing system would be beneficial. More specifically, a breakaway valve assembly for use in a fuel dispensing system that would allow a worker to connect certain testing equipment while minimizing the spillage of fuel during the process would be particularly beneficial.

### SUMMARY

Aspects and advantages of the invention will be set forth in part in the following description, or may be obvious from the description, or may be learned through practice of the invention.

In one exemplary embodiment of the present disclosure, a valve assembly for a fuel dispensing system is provided. The valve assembly includes a valve body defining a fluid inlet in fluid communication with a fuel source, a fluid outlet in fluid communication with a fuel dispenser, and a channel for the flow of fuel from the fluid inlet to the fluid outlet. The valve assembly also includes a test port extending from the valve body and defining a downstream end. The test port is in fluid communication with the channel in the valve body. Additionally, the valve assembly includes a test port valve positioned upstream from the downstream end of the test port, The test port valve is moveable between an open position wherein fluid may flow through the test port and a closed position wherein the test port valve blocks fluid from flowing through the test port.

In another exemplary embodiment of the present disclosure, a valve assembly for use in a fuel dispensing system is provided. The valve assembly includes a valve body defining a channel for the flow of a fluid and the channel extends between a fluid inlet and a fluid outlet. The valve assembly also includes a shutoff valve positioned in the channel of the valve body and moveable between an open position and a closed position. The shutoff valve is configured to block the flow of fluid from the fluid outlet when it is in the closed position. Additionally, the valve assembly includes a test port in fluid communication with the channel upstream from the shutoff valve. The test port defines a downstream end. The valve assembly also includes a test port valve positioned upstream from the downstream end of the test port and moveable between an open position and a closed position. The test port valve is configured to block the flow of fluid through the test port when in the closed position.

In still another exemplary embodiment of the present disclosure, an emergency breakaway valve assembly for use in a fuel dispensing system is provided. The valve assembly includes a valve body defining an outer wall extending between a fluid inlet and a fluid outlet, and a shutoff valve positioned in the valve body. The shutoff valve is moveable between an open position and a closed position, and is configured to block a flow of fluid from the fluid outlet when it is in the closed position. The valve assembly also includes a test port extending from the outer wall of the valve body from a position upstream from the shutoff valve, the test port defining a downstream end. Additionally, the valve assembly includes a first valve positioned at the downstream end of the test port, and a test port valve positioned upstream from the first valve.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 depicts a fuel dispensing system in accordance with aspects of an exemplary embodiment of the present disclosure.

FIG. 2 provides a perspective view of a valve assembly in accordance with aspects of an exemplary embodiment of the present disclosure.

FIG. 3 provides a front cross-sectional view of a valve assembly in accordance with aspects of an exemplary embodiment of the present disclosure.

FIG. 4 provides a side cross-sectional view of a valve assembly in accordance with aspects of an exemplary embodiment of the present disclosure.

FIG. 5 provides a side cross-sectional view a valve assembly in accordance with aspects of another exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

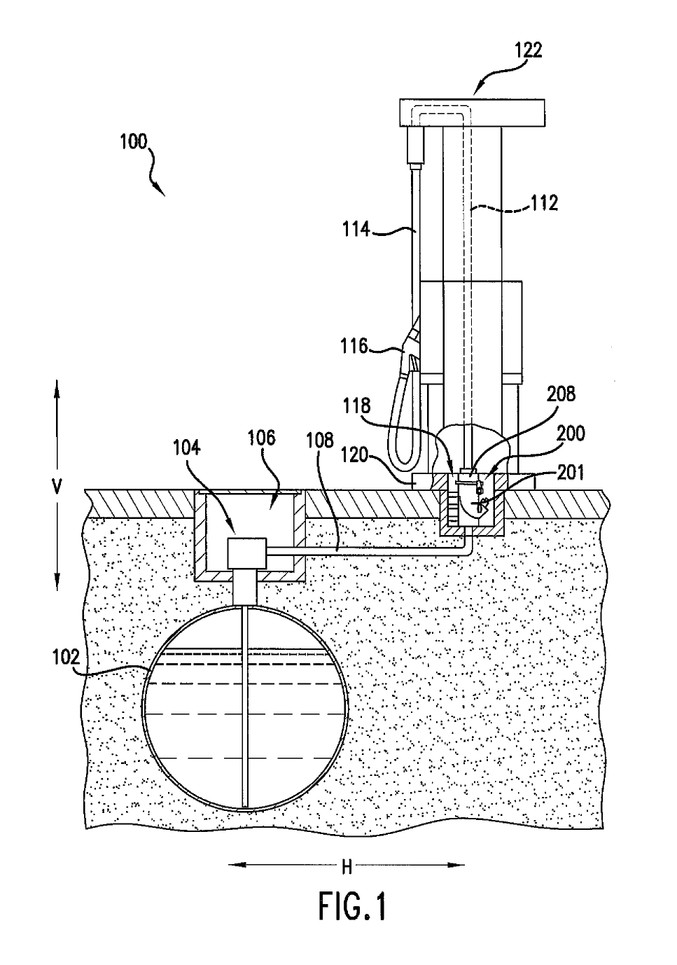

Referring now to the drawings, FIG. 1 provides an exemplary embodiment of a fuel dispensing system 100 of the present disclosure. As shown, the exemplary system 100 includes a fuel supply, such as a fuel storage tank 102, in fluid communication with a connection pipe 108. Auxiliary equipment 104 is provided within an auxiliary equipment compartment 106. The auxiliary equipment 104 may include a pump configured to pump fuel stored in the fuel storage tank 102 through the connection pipe 108 and to a dispensing station 122. Within a sump area 118 at a base of the fuel dispensing station 122, a valve assembly 200 is provided. For the exemplary embodiment of FIG. 1, the valve assembly 200 establishes a fluid connection between the connection pipe 108 and an internal pipe 112 of the fuel dispensing station 122. The pipe 112 attaches to a flexible hose 114 and the flexible hose 114 attaches to a nozzle 116. In response to a user input, the system 100 is configured to provide fuel from the fuel storage tank 102, through the connection pipe 108, through the valve assembly 200, through the pipe 112 and flexible hose 114, and through the nozzle 114 to, for example, a fuel tank in a car. In addition, a raised island 120 is provided around the base of fuel station 122. The island 120 may be comprised of a cement, or any other material suitable for establishing a barrier around the fuel dispensing station 122.

It should be appreciated, however, that the fuel dispensing system 100 of FIG. 1 is provided by way of example only. In other exemplary embodiments of the present disclosure, the valve assembly 200 may alternatively be used in any other suitable fuel dispensing system 100. For example, the valve assembly 200 may be used in a fuel dispensing system 100 that includes an above ground fuel storage tank 102 or a different configuration for pipe 112 and hose 114.

The exemplary fuel dispensing system 100 incorporating the valve assembly 200 is designed to minimize any fuel spillage in the event of an accident. Accordingly, for the exemplary embodiment of FIG. 1, the valve assembly 200 is a breakaway valve assembly. Such a construction, as will be discussed in greater detail below, allows the fuel dispensing system 100 to minimize fuel spillage in the event that a car runs into or drives through the fuel dispensing station 122.

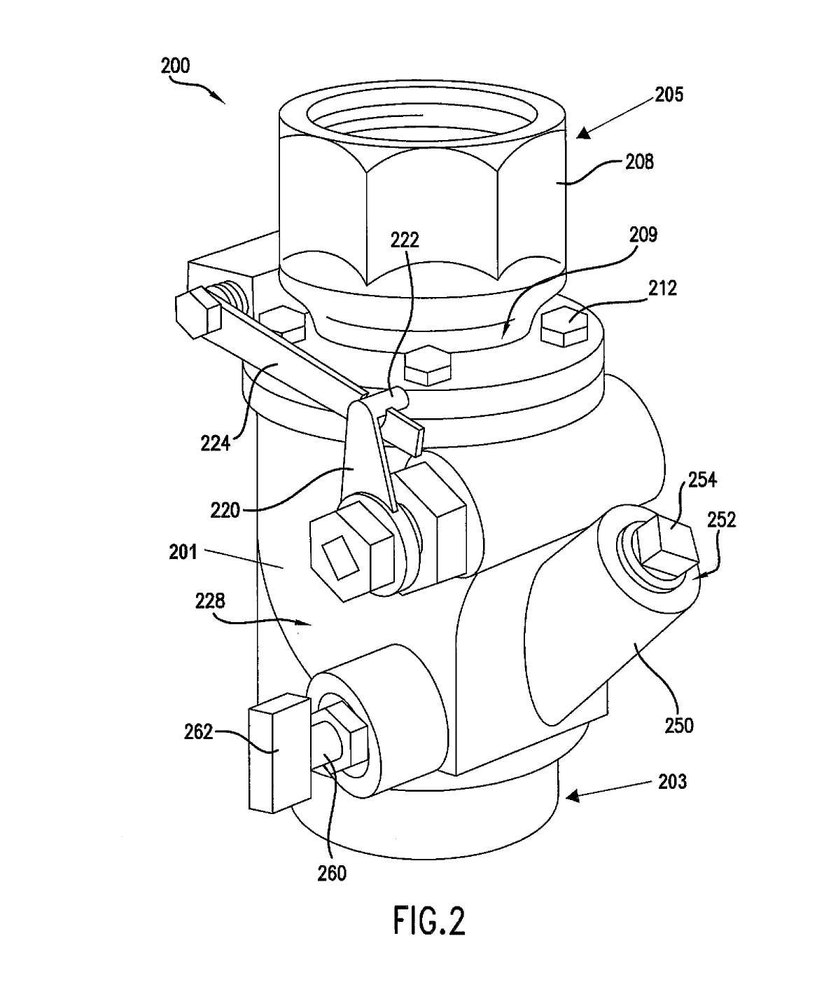

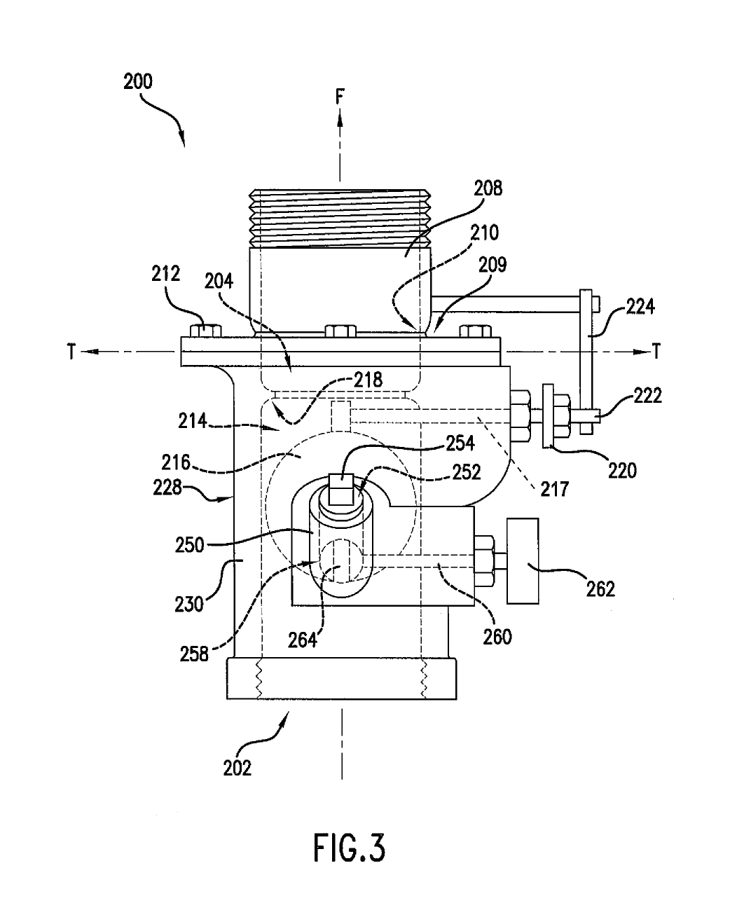

A perspective view of an exemplary valve assembly 200 is provided in FIG. 2. The exemplary valve assembly 200 defines an upstream end 203 and a downstream end 205, and includes a valve body 201 and a connection member 208. The valve body 201 is removably attached to a base 209 of the connection member 208. The upstream end 203 is configured to be attached to the connection pipes 108 and the downstream end 205 is configured to be attached to the pipe 112. In the event of an accident wherein a predetermined amount of force is applied to the fuel dispensing station 122, the valve assembly 200 is designed to fail at location near the base 209 of the connection member 208. In such a case, a connection rod 224 is designed to pull a lever 220 in communication with a a shutoff valve 214 (see FIGS. 3-5, below) and prevent fuel from flowing through the exemplary valve assembly 200.

In addition, the exemplary valve assembly 200 includes a test port 250 extending from the body 201 of the valve assembly 200. The test port 250 is configured for allowing a user to test the fuel dispensing system 100 between the fuel dispensing station 122 and the fuel supply 102.

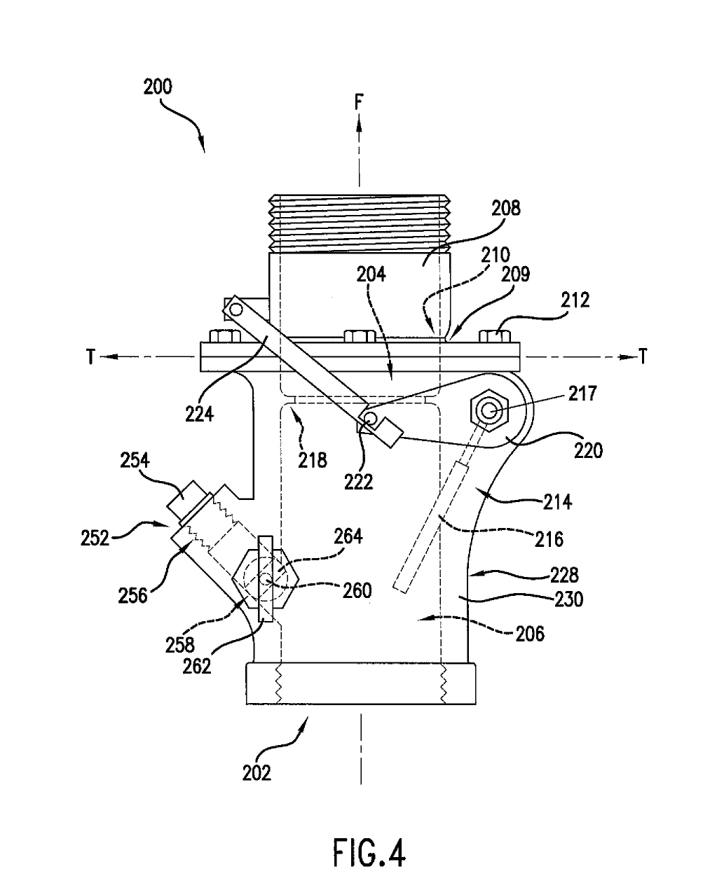

Referring now to FIGS. 3 and 4, a side cross-sectional view and a front cross-sectional view of an exemplary valve assembly 200 are provided. The exemplary valve assembly 200 of FIGS. 3 and 4 includes a valve body 201 defining a fluid inlet 202 and a fluid outlet 204. The fluid inlet 202 is configured to be in fluid communication with a fuel source, such as the fuel storage tank 102 of FIG. 1, and the fluid outlet 204 is configured to be in fluid communication with a fuel dispenser, such as the fuel dispensing station 122 of FIG. 1. Further, the valve body 201 defines a channel 206 for the flow of fuel from the fluid inlet 202 to the fluid outlet 206 and an outer wall 230 extending between the fluid inlet 202 and fluid outlet 204. For the exemplary embodiment of FIG. 1, fuel flows in a direction F from the fluid inlet 202 to the fluid outlet 204 when the fuel dispensing station 122 is in operation. Additionally, the fluid outlet 204 of the valve assembly defines a top plane T, which for the exemplary embodiment of FIGS. 3 and 4 is approximately perpendicular to the fuel flow direction F.

In certain exemplary embodiments, the valve assembly 200 may be positioned in a fuel dispensing system 100 such that the top plane T is no higher in a vertical direction V (see FIG. 1) than the ground surrounding where a dispensing station 122 is positioned. For example, the body 201 of the valve assembly 200 may be positioned within a sump area 118 below the fuel dispensing station 122. In alternative embodiments, however, the top plane T of the exemplary valve assembly 200 may be positioned in a fuel dispensing system 100 such that the top plane T is no higher in a vertical direction V (see FIG. 1) than a raised island 120 surrounding at least a portion of a fuel dispensing station 122. Either of such a configurations may assist in protecting the body 201 of the valve assembly 200 in the event of an accident.

At the fluid outlet 204, the valve body 201 is removably attached to the connection member 208 by a plurality of bolts 212 positioned at a base 209 of the connection member 208. The connection member 208 defines a fail point, which for the exemplary embodiment of FIGS. 3 and 4 is a machined groove 210, positioned just above its base 209. The connection member 208 is configured to break off from the body 201 of the valve assembly 200 at the machined groove 210 in response to a predetermined amount of force from, for example, an accident. Accordingly, the exemplary valve assembly 200 may be referred to as a breakaway valve assembly.

In order to minimize the spillage of fuel when the connection member 208 breaks off from the body 201, the exemplary valve assembly 200 of FIGS. 3 and 4 includes a shutoff valve 214 positioned within the body 201 of the valve assembly 200 and in communication with the connection member 208. More particularly, for the exemplary valve assembly 200 of FIGS. 3 and 4, the shutoff valve 214 is positioned in the channel 206 of the valve body 201. In addition, the shutoff valve 214 includes a flap 216 configured to rotate about a shaft 217, with the shaft 217 being connected to a lever 220. The lever 220 includes a pin 222, which is in communication with a connection rod 224. The connection rod 224 is attached to the connection member 208 above the machined groove 210. The exemplary valve assembly 200 therefore establishes a physical connection between the shutoff valve 214 and the connection member 208 at a position opposite the fail point from the valve body 201. For example, in the exemplary embodiment of FIGS. 3 and 4, the exemplary valve assembly 200 establishes a physical connection between the shutoff valve 214 and the connection member 208 at a position above the machined groove 210 defined by the connection member 208.

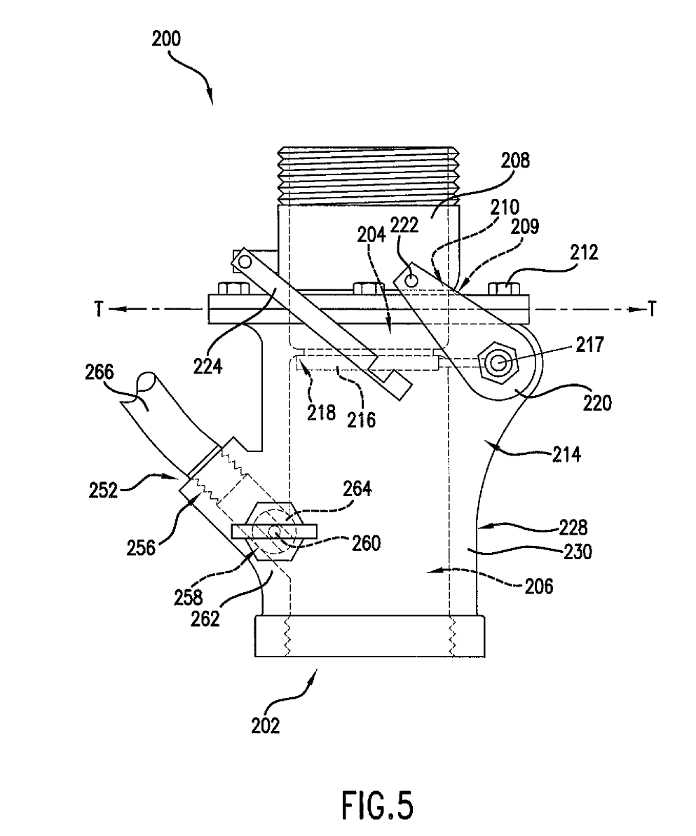

In addition, the shutoff valve is moveable between an open position, as shown in FIGS. 3 and 4, and a closed position, as shown in FIG. 5. When moving from the open position to the closed position, the flap 216 rotates about the shaft 217, until it hits a valve seat 218 positioned within the channel 206 of the body 201 of the valve assembly 200. The shutoff valve 214 may be moved to the closed position when, for example, a predetermined amount of force is applied to the connection member 208, such that the connection member 208 breaks away at the machined groove 210 and the connection rod 224 pulls the pin 222 and lever 220. The shutoff valve 214 may be configured such that the flow of fuel through the channel 206 assists in closing the shutoff valve 214 and a positive pressure in the channel 206 keeps the shutoff valve 214 in the closed position. As indicated by the figures, the shutoff valve 214 is configured to block the flow of fluid from the fluid outlet 204 when in the closed position. Alternatively, the shutoff valve 214 may be manually moved to the closed position by disconnecting the connection rod 224 and the pin 222 and rotating the lever 220.

It should be appreciated, however, that in other exemplary embodiments of the present disclosure, the valve assembly 200 may have any other suitable configuration for blocking the flow of fuel through the channel 206, or alternatively may not include any means for stopping the flow of fuel through the channel 206. For example, in other exemplary embodiments, the valve assembly 200 may have any other suitable type of shutoff valve 214, any suitable means of communication or connection between the shutoff valve 214 and the connection member 208, any suitable means for connecting the connection member 208 to the valve body 201, and/or any suitable configuration for establishing a fail point within the valve body 201 or connection member 208. It should also be appreciated that in other exemplary embodiments of the present disclosure, the valve assembly 200 may be a singular unit. For example, the valve body 201 may be made integrally with the connection member 208. Examples of various other suitable configurations of valve assemblies, shutoff valves, and connection members may be seen in, for example, U.S. Pat. Nos. 8,020,576; 5,244,006; 5,765,587; and 8,387,646; each of which are hereby incorporated fully by reference.

With continued reference to FIGS. 3 and 4, the exemplary valve assembly 200 also includes a test port 250 extending from the valve body 201. The test port 250 defines a downstream end 252, which for the exemplary embodiment of FIGS. 3 and 4 does not extend through the top plane T defined by the fluid outlet 204. In addition, when the shutoff valve 214 is in the closed position (see FIG. 5), the test port 250 is in fluid communication with the channel 206 in the valve body 201 at a location upstream from the shutoff valve 214. For the exemplary embodiment of FIGS. 3 and 4, the test port 250 is configured to allow for testing of certain portions of the fuel dispensing system 100. For example, the test port 250 may allow for testing of the fuel storage tank 102, the auxiliary equipment 104, and/or the connection pipes 108 to determine, for example, pressure loss and/or leakage within the fuel dispensing system 100. The shutoff valve 214 may be manually moved to the closed position to allow for such testing.

The exemplary valve assembly 200 additionally includes a first valve 254 positioned at the downstream end 252 of the test port 250. As shown, the first valve 254 is a plug removably attached to the downstream end 252 of the test port 250. The plug and the downstream end 252 of the test port 250 each comprise a corresponding plurality of circumferential grooves 256 configured to engage one another when the plug is positioned in the downstream end 252 of the test port 250. Accordingly, when the first valve 254, or plug, is in a closed position, as shown in FIGS. 3 and 4, fluid may not flow through the test port 250. In addition, when the first valve 254, or plug, is in the open position (i.e., unscrewed and removed from the test port 250), the circumferential grooves 256 in the test port 250 may allow for the connection of one or more pieces of testing equipment (see FIG. 5).

The exemplary valve assembly 200 further includes a test port valve 258. The test port valve 258 is positioned upstream from the downstream end 252 of the test port 250 and upstream from the first valve 254. More particularly, for the exemplary embodiment of FIGS. 3 and 4, the test port valve 258 is a ball valve positioned at an upstream end of the test port 250, where the test port 250 meets the channel 206 in the body 201 of the valve assembly 200. Additionally, the test port valve 258 is moveable between an open position (see FIG. 5), wherein fluid may flow through the test port 250, and a closed position, as shown in FIGS. 3 and 4, wherein the test port valve 258 blocks fluid from flowing through the test port 250. When in the closed position, a passage 264 in the ball valve 258 is positioned such that fluid may not flow through the ball valve 258. Conversely, when in the open position, as shown in FIG. 5, the passage 264 is positioned to allow a fluid to flow through the ball valve 258 and into and through the test port 250. Further, for the exemplary embodiment of FIGS. 3 and 4, the valve assembly 200 additionally includes a shaft 260 extending from the ball valve 258 through the outer wall 230 and an outside surface 230 of the body 201 of the valve assembly 200 to attach to a handle 262. The handle 262 is configured for moving the test port valve 258, or ball valve 258, between the open position and the closed position.

The configuration of the exemplary valve assembly 200 of FIGS. 3 and 4 allows for the downstream end 252 of the test port 250 to be, for example, connected to testing equipment 220 (see FIG. 5) without inhibiting the movement of the test port valve 258 between the open position and the closed position. For example, the test port valve 258 may be moved between the open position (see FIG. 5) and the closed position (see FIGS. 3 and 4) by the handle 262, while the testing equipment 220 is attached to the downstream end 252 of the test port 250. Such a configuration may allow for testing of the fuel dispensing system 100 while minimizing the amount of fuel spilled or spewed from the test port 250 when attaching the testing equipment to the test port 250.

Accordingly, in one exemplary aspect of the present disclosure, a user may test the pressure loss and/or leakage of the fuel dispensing system 100 by first closing the shutoff valve 214 within the valve body 201 of the valve assembly 200. The user may also move the test port valve 258 to the closed position, or ensure the test port valve 258 is in the closed position. Then, the user may open the first valve (i.e., remove the plug), attach the testing equipment, and conduct any required testing of the fuel dispensing system. When the testing is complete, the user may move the test port valve back to the closed position using the handle, and disconnect the testing equipment. The user may then close the first valve (i.e., screw the plug back in). Such a process may allow the user to conduct certain testing activities of the fuel dispensing system 100 while minimizing any fuel spillage and without having to turn off the fuel pump or otherwise depressurizing the fuel dispensing system 100.

It should be appreciated, however, that in other exemplary embodiments of the present disclosure, the valve assembly 200 may have any other suitable configuration for minimizing the amount of fuel spilled from the test port 250. For example, in other exemplary embodiments, the valve assembly 200 may not include the first valve or plug 254 positioned at the downstream end 252 of the test port 250. In such an embodiment, the test port valve 258 may be the only valve preventing a fluid from flowing through the test port 250. Additionally, in such an embodiment, the downstream end 252 may have any suitable configuration for attaching to testing equipment. For example, the downstream end 252 of the test port 250 may be configured to be used with a quick-connect hose attachment. It should further be appreciated that in other exemplary embodiments of the present disclosure, the test port valve 258 may not be a ball valve, and instead may be any other type of valve suitable for being moved between an open and closed position. For example, the test port valve 258 may instead be a butterfly valve, a gate valve, a globe valve, a needle valve, a pinch valve, etc. In still other exemplary embodiments of the present disclosure, the test port valve 258 may be positioned at any suitable location upstream from the downstream end 252 of the test port 250. For example, in other exemplary embodiments, the test port valve 258 may be positioned in the middle of the test port 250.

Referring now to FIG. 5, an exemplary embodiment of the valve assembly 200 is provided with the shutoff valve 214 in the closed position, the test port valve 258 in the open position, and testing equipment 220 attached to the downstream end 252 of the test port 250. As shown, when the test port valve 258, or ball valve 258, is in the open position, the passage 264 is aligned with the test port 250 such that fluid may flow through the test port valve 258 and into and through the test port 250.

While the present subject matter has been described in detail with respect to specific exemplary embodiments and methods thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A valve assembly for a fuel dispensing system, comprising:
a valve body defining a fluid inlet in fluid communication with a fuel source, a fluid outlet in fluid communication with a fuel dispenser, and a channel for a flow of fuel from the fluid inlet to the fluid outlet;
a test port extending from the valve body and defining a downstream end, the test port in fluid communication with the channel in the valve body;
a test port valve positioned upstream from the downstream end of the test port, the test port valve moveable between an open position wherein fluid may flow through the test port and a closed position wherein the test port valve blocks fluid from flowing through the test port.

2. The valve assembly of claim 1, further comprising:
a first valve positioned at the downstream end of the test port.

3. The valve assembly of claim 2, wherein the first valve is a plug removably attached to the downstream end of the test port.

4. The valve assembly of claim 1, wherein the test port valve is a ball valve.

5. The valve assembly of claim 1, further comprising:
a handle configured for moving the test port valve between the open position and the closed position.

6. The valve assembly of claim 1, further comprising:
a shutoff valve positioned in the valve body and moveable between an open position and a closed position, the shutoff valve configured to block the flow of fuel from the fluid outlet when in the closed position, wherein the test port is in fluid communication with the channel at a location upstream from the shutoff valve.

7. The valve assembly of claim 6, wherein the valve body is attached at the fluid outlet to a connection member, the connection member being in communication with the shutoff valve.

8. The valve assembly of claim 7, wherein the connection member defines a fail point, and the shutoff valve is in communication with the connection member at a position opposite the fail point from the valve body.

9. The valve assembly of claim 1, wherein the downstream end of the test port is configured for connecting to testing equipment without inhibiting the movement of the test port valve between the open position and the closed position.

10. A valve assembly for use in a fuel dispensing system, comprising:
a valve body defining a channel for a flow of fluid, the channel extending between a fluid inlet and a fluid outlet;
a shutoff valve positioned in the channel of the valve body and moveable between an open position and a closed position, the shutoff valve configured to block the flow of fluid from the fluid outlet when in the closed position;
a test port in fluid communication with the channel upstream from the shutoff valve, the test port defining a downstream end; and
a test port valve positioned upstream from the downstream end of the test port and moveable between an open position and a closed position, the test port valve configured to block a flow of fluid through the test port when in the closed position.

11. The valve assembly of claim 10, further comprising:
a first valve positioned at the downstream end of the test port downstream from the test port valve.

12. The valve assembly of claim 11, wherein the first valve is a plug removably attached to the test port at the downstream end.

13. The valve assembly of claim 10, wherein the test port extends from the valve body.

14. The valve assembly of claim 13, wherein fluid outlet of the valve body defines a top plane, and wherein the test port does not extend through the top plane.

15. The valve assembly of claim 10, wherein the test port valve is a ball valve.

16. The valve assembly of claim 10, further comprising:
a handle configured for moving the test port valve between the open position and the closed position.

17. The valve assembly of claim 16, wherein the valve body further comprises an outer surface, and wherein the handle is positioned outside the outer surface of the valve body.

18. The valve assembly of claim 10, wherein the valve body is attached at the fluid outlet to a connection member, the connection member defining a fail point, and wherein the shutoff valve is in communication with the connection member at a position opposite the fail point from the valve body.

19. The emergency breakaway valve assembly of claim 10, wherein the downstream end of the test port defines a plurality of circumferential grooves configured for attaching the test port to testing equipment when the test port valve is in the closed position.

20. An emergency breakaway valve assembly for use in a fuel dispensing system, comprising:
a valve body defining an outer wall extending between a fluid inlet and a fluid outlet;
a shutoff valve positioned in the valve body and moveable between an open position and a closed position, the shutoff valve configured to block a flow of fluid from the fluid outlet when in the closed position;
a test port extending from the outer wall of the valve body from a position upstream from the shutoff valve, the test port defining a downstream end;
a first valve positioned at the downstream end of the test port; and
a test port valve positioned upstream from the first valve.
